(19) United States
(12) Patent Application Publication
(10) Pub. No.: US 2015/0032565 A1
(43) Pub. Date: Jan. 29, 2015

(54) SYSTEMS AND METHODS FOR RECOMMENDING MERCHANTS

(71) Applicant: MasterCard International Incorporated, Purchase, NY (US)

(72) Inventors: David Weis, Boerne, TX (US); Gary Sofko, Purdys, NY (US); Gary Kearns, Greenwich, CT (US)

(73) Assignee: MasterCard International Incorporated, Purchase, NY (US)

(21) Appl. No.: 13/951,215

(22) Filed: Jul. 25, 2013

(51) Int. Cl. G06Q 30/06

(52) U.S. Cl. CPC G06Q 30/0631
USPC 705/26.7

(57) ABSTRACT

A computer system for recommending merchants to a candidate consumer is provided. The computer system includes a memory device in communication with a processor. The processor is programmed to collect transaction information for transactions between a plurality of payment cardholders and a plurality of merchants over a predetermined time period. The transaction information includes a merchant identifier associated with each transaction. The processor generates a list of cardholders based on the transaction information. The cardholder list includes a residential zip code associated with each cardholder. The processor then determine a total number of transactions and a number of local and unique cardholders for each merchant identifier based, at least in part, on the transaction information and/or the cardholder residential zip codes. Based on the total number of transactions and the number of local and unique cardholders, the processor then generates a list of recommended merchants.

### BACKGROUND OF THE DISCLOSURE

The field of the disclosure relates generally to methods and systems for recommending merchants and, more particularly, to methods and systems for recommending merchants to a potential consumer based at least in part on the potential consumer's search location and payment transaction histories of local payment cardholders

Consumers today are provided with an increasing number of segments of entertainment choices available, as well as, an increasing number of merchants available in each segment. A segment is a group of merchants offering a similar entertainment experience, such as a dining segment, an events segment, a night club segment, and an activities segment. For example, in many cities, consumers have hundreds if not thousands of restaurant options when they desire to eat. Moreover, even when the restaurant options are narrowed by restaurant category or cuisine, there may still be an inconveniently large number of restaurant options presented to the consumer. Additionally, new restaurants may become available and/or smaller restaurants known only to local residents of a city may exist without the consumer's knowledge.

To address these issues, various known methods exist that provide restaurant recommendations to consumers. For example, Internet websites exist that enable consumers to provide restaurant reviews or score the restaurant, as well as, provide descriptive information (e.g., average prices, type of cuisine) about the restaurant. Oftentimes, consumers can provide their comments and information for a restaurant in addition to a professional reviewer, thereby providing additional opinions for consumers. One problem that arises such known methods is that local residents or “locals” are often less likely to provide reviews at restaurants in which they frequent as previous experience at a restaurant is typically what keeps locals returning. Additionally, in some instances, consumers are more likely to post a review based on a bad experience at a restaurant than they are to post a positive review, which can bias recommendations for other consumers.

### BRIEF DESCRIPTION OF THE DISCLOSURE

In one embodiment, a computer system for recommending merchants to a candidate consumer is provided. The computer system includes a memory device in communication with a processor. The processor is programmed to collect transaction information for transactions between a plurality of payment cardholders and a plurality of merchants over a predetermined time period. The transaction information includes a merchant identifier associated with each transaction. The processor generates a list of cardholders based on the transaction information. The cardholder list includes a residential zip code associated with each cardholder. The processor then determines a total number of transactions and a number of local and unique cardholders for each merchant identifier based, at least in part, on the transaction information and/or the cardholder residential zip codes. Based on the total number of transactions and the number of local and unique cardholders, the processor then generates a list of recommended merchants.

In another embodiment, a computer-implemented method is provided for recommending at least one merchant of a plurality of merchants to a candidate consumer using a merchant analytic (MA) computer system. The MA computer system is in communication with a memory device. The method includes collecting transaction information for transactions between a plurality of payment cardholders and the plurality of merchants over a predetermined time period. The transaction information includes a merchant identifier associated with each transaction. The method also includes generating a list of cardholders based on the transaction information. The cardholder list includes a residential zip code associated with each cardholder. The method further includes determining a total number of transactions and a number of local and unique cardholders for each merchant identifier based, at least in part, on the transaction information and/or the cardholder residential zip codes. The method also includes generating a list of merchants based on the total number of transactions and the number of local and unique cardholders.

In yet another embodiment, one or more computer-readable storage media provided that include computer-executable instructions embodied thereon for recommending at least one merchant of a plurality of merchants to a candidate cardholder. When executed by at least one processor, the computer-executable instructions cause the processor to collect transaction information for transactions between a plurality of payment cardholders and a plurality of merchants over a predetermined time period. The transaction information includes a merchant identifier associated with each transaction. The processor generates a list of cardholders based on the transaction information. The cardholder list includes a residential zip code associated with each cardholder. The processor then determines a total number of transactions and a number of local and unique cardholders for each merchant identifier based, at least in part, on the transaction information and/or the cardholder residential zip codes. Based on the total number of transactions and the number of local and unique cardholders, the processor then generates a list of recommended merchants.

### BRIEF DESCRIPTION OF THE DRAWINGS

FIGS. 1-9 show exemplary embodiments of the methods and systems described herein.

FIG. 1 is a schematic diagram illustrating an example multi-party payment card industry system for enabling ordinary payment-by-card transactions in which merchants and card issuers do not necessarily have a one-to-one relationship.

FIG. 2 is a simplified block diagram of an example merchant analytic computer system including a plurality of computer devices including a user device having a merchant recommender application in accordance with one example embodiment of the present invention.

FIG. 3 is an expanded block diagram of an example embodiment of a server architecture of the merchant analytic computer system including the plurality of computer devices in accordance with one example embodiment of the present invention.

FIG. 4 illustrates an example configuration of a client system shown in FIGS. 2 and 3.

FIG. 5 illustrates an example configuration of a server system shown in FIGS. 2 and 3.

FIG. 6 is a block diagram showing an operation of the merchant analytic computer system shown in FIG. 2.

FIG. 7 is a flow diagram of an example method of recommending merchants to a candidate customer using the merchant analytic computer system shown in FIG. 2 coupled to a user device having a merchant recommender application stored thereon.

FIG. 8 is a diagram of example computing devices that may be used in the merchant analytic computer system shown in FIG. 2.

FIG. 9 is a diagram of components of one or more example computing devices that may be used in the merchant analytic computer system shown in FIG. 2.

### DETAILED DESCRIPTION OF THE DISCLOSURE

The following detailed description illustrates embodiments of the invention by way of example and not by way of limitation. The description clearly enables one skilled in the art to make and use the disclosure, describes several embodiments, adaptations, variations, alternatives, and uses of the disclosure, including what is presently believed to be the best mode of carrying out the disclosure. The disclosure is described as applied to an example embodiment, namely, methods and systems for providing cardholders objective and reputable information for making entertainment decisions among numerous available merchants. More specifically, the disclosure describes a merchant analytic computer system (also referred to as “MA computer system”) configured to collect transaction data for a plurality of payment cardholders transacting with a plurality of merchants, generate a list of merchants based on a number of local and unique cardholders, and display a list of recommended merchants based on a search location input by a user. The MA computer system is in communication with a user device having a merchant recommender application (also referred to as “recommender app”) stored thereon such that a user can input a search location to be considered by the MA computer system, and view output from the MA computer system. The output includes recommendations for merchants that are most transacted with by local residents.

The MA computer system is configured to recommend a merchant to a potential consumer, or also referred to as “candidate consumer”. In the example embodiment, the MA computer system is configured for use with a payment card processing network such as, for example, an interchange network. The MA computer system includes a memory device and a processor in communication with the memory device and is programmed to communicate with the payment network to receive transaction information for a plurality of cardholders. The payment network is configured to process payment card transactions between the merchant and its acquirer bank, and the cardholder and their issuer bank. Transaction information includes data relating to purchases made by cardholders at various merchants during a predetermined time period, including a merchant identifier. In some embodiments, the plurality of purchases made by the cardholders are related to each other as being in the same market segment, for example, but not limited to, a dining segment, an events segment, a night club segment, or an activities segment.

In the example embodiment, using the transaction information, the MA computer system generates a list of cardholders (i.e., “cardholder list”) that have completed at least one transaction during the predetermined time period. The MA computer system identifies each cardholder's residential zip code from the transaction information and sorts the cardholder list by cardholders according to zip code.

The MA computer system then generates a list of merchants (i.e., “merchant list”) located in each zip code on the cardholder list. In the example embodiment, the MA computer system generates a list of restaurants. However, in alternate embodiments, the list may include merchants from any other type of industry. The MA computer system is configured to recommend restaurants favored by local residents. Accordingly, in the example embodiment, the restaurant list may exclude fast-food restaurants and/or chain restaurants that may be less frequented by locals. The merchant list includes location data such as an address and/or latitude/longitude data for each merchant.

For each merchant on the merchant list, the MA computer system determines a total number of transactions completed for each merchant identifier over the predetermined time period. The MA computer system then determines a number of local cardholders involved in the total transactions for each merchant identifier using the cardholder list. In the example embodiment, a cardholder is “local” if the first three numbers of the cardholder's zip code are equal to the first three numbers of the merchant's zip code.

To prevent skewed results, the MA computer system also determines a number of unique cardholders that transacted with each merchant during the predetermined time period. In the example embodiment, a cardholder is “unique” if the cardholder has not previously transacted with the merchant during the predetermined time period. Counting only unique cardholders protects the merchant popularity analysis by differentiating between merchants having a small, loyal customer-base and merchants having a large, well-known customer-base. The merchant list is updated to include at least the merchant location data, the total transactions, and the total local and unique cardholders. In one embodiment, the MA computer system sorts the merchant list in descending order with the merchant having the highest ratio of local and unique transactions to total transactions at the top. The merchant list is stored in a memory and is updated as often as is desired. Based on the collected information, non-local, unique transactions may also be determined, if desired.

In the example embodiment, upon receiving a search location from a user, the MA computer system sorts the merchant list according to a search location input by the candidate consumer. The MA computer system then provides a list of recommended merchants to the candidate consumer using the recommender app, wherein the list is based on the merchant list sorted by the number of local and unique transactions relative to total transactions.

A technical effect of the systems and methods described herein is achieved by performing at least one of the following steps: (a) receiving, by a MA computer system, transaction information for a plurality of cardholders from a payment network, wherein the transaction information includes a merchant identifier and data relating to purchases made by the plurality of cardholders at a plurality of merchants during a predetermined time period; (b) generating a cardholder list based on the transaction information including a residential zip code associated with each cardholder; (c) for each zip code on the cardholder list, generating a merchant list including each merchant identifier transacted with during the predetermined time period; (d) determining a total number of transactions for each merchant identifier based, at least in part, on the transaction information; (e) determining a number of local and unique cardholders associated with each merchant identifier based, at least in part, on the transaction information and the cardholder residential zip codes; (f) calculating a ratio between the number of local and unique cardholders and the total number of transactions for each zip code; (g) sorting the merchant list in descending order based on the calculated ratio; (h) receiving search preferences from a candidate consumer inputted using a recommender app stored on a user computing device; (i) determining which merchants from the merchant list are applicable to the candidate consumer search preferences; (j) sorting the applicable merchants based on the calculated ratio; and (k) providing a list of recommended merchants to the candidate consumer, wherein the list is based on the sorted applicable merchants.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, and/or computers. Each type of transactions card can be used as a method of payment for performing a transaction.

In one embodiment, a computer program is provided, and the program is embodied on a computer readable medium. In an exemplary embodiment, the system is executed on a single computer system, without requiring a connection to a sever computer. In a further exemplary embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of AT&T located in New York, N.Y.). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

The following detailed description illustrates embodiments of the invention by way of example and not by way of limitation. It is contemplated that the invention has general application to processing financial transaction data by a third party in industrial, commercial, and residential applications.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present invention are not intended to be interpreted as excluding the existence of additional embodiments that also incorporate the recited features.

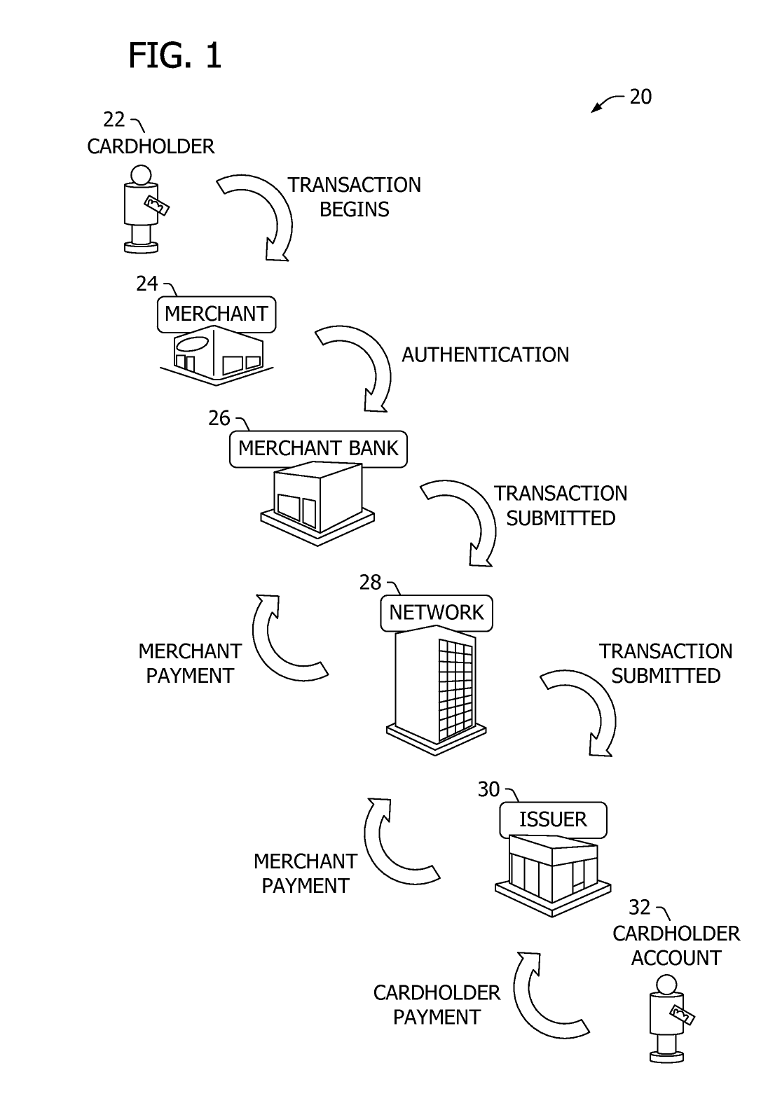

FIG. 1 is a schematic diagram illustrating an example multi-party transaction card industry system 20 for enabling ordinary payment-by-card transactions in which merchants 24 and card issuers 30 do not need to have a one-to-one special relationship. Embodiments described herein may relate to a transaction card system, such as a credit card payment system using the MasterCard® interchange network. The MasterCard® interchange network is a set of proprietary communications standards promulgated by MasterCard International Incorporated® for the exchange of financial transaction data and the settlement of funds between financial institutions that are members of MasterCard International Incorporated®. (MasterCard is a registered trademark of MasterCard International Incorporated located in Purchase, N.Y.).

In a typical transaction card system, a financial institution called the “issuer” issues a transaction card, such as a credit card, to a consumer or cardholder 22, who uses the transaction card to tender payment for a purchase from a merchant 24. To accept payment with the transaction card, merchant 24 must normally establish an account with a financial institution that is part of the financial payment system. This financial institution is usually called the “merchant bank,” the “acquiring bank,” or the “acquirer.” When cardholder 22 tenders payment for a purchase with a transaction card, merchant 24 requests authorization from a merchant bank 26 for the amount of the purchase. The request may be performed over the telephone, but is usually performed through the use of a point-of-sale terminal, which reads cardholder's 22 account information from a magnetic stripe, a chip, or embossed characters on the transaction card and communicates electronically with the transaction processing computers of merchant bank 26. Alternatively, merchant bank 26 may authorize a third party to perform transaction processing on its behalf. In this case, the point-of-sale terminal will be configured to communicate with the third party. Such a third party is usually called a “merchant processor,” an “acquiring processor,” or a “third party processor.”

Using an interchange network 28, computers of merchant bank 26 or merchant processor will communicate with computers of an issuer bank 30 to determine whether cardholder's 22 account 32 is in good standing and whether the purchase is covered by cardholder's 22 available credit line. Based on these determinations, the request for authorization will be declined or accepted. If the request is accepted, an authorization code is issued to merchant 24.

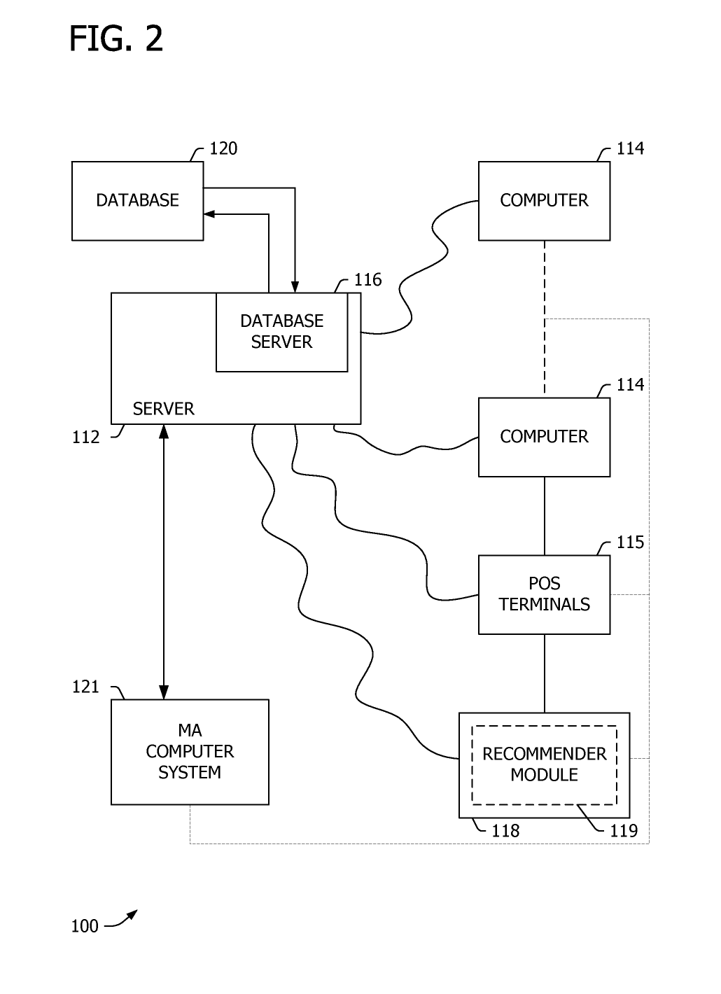

When a request for authorization is accepted, the available credit line of cardholder's 22 account 32 is decreased. Normally, a charge for a payment card transaction is not posted immediately to cardholder's 22 account 32 because bankcard associations, such as MasterCard International Incorporated®, have promulgated rules that do not allow merchant 24 to charge, or “capture,” a transaction until goods are shipped or services are delivered. However, with respect to at least some debit card transactions, a charge may be posted at the time of the transaction. When merchant 24 ships or delivers the goods or services, merchant 24 captures the transaction by, for example, appropriate data entry procedures on the point-of-sale terminal. This may include bundling of approved transactions daily for standard retail purchases. If cardholder 22 cancels a transaction before it is captured, a “void” is generated. If cardholder 22 returns goods after the transaction has been captured, a “credit” is generated. Interchange network 28 and/or issuer bank 30 stores the transaction card information, such as a type of merchant, amount of purchase, date of purchase, in a database 120 (shown in FIG. 2).

After a purchase has been made, a clearing process occurs to transfer additional transaction data related to the purchase among the parties to the transaction, such as merchant bank 26, interchange network 28, and issuer bank 30. More specifically, during and/or after the clearing process, additional data, such as a time of purchase, a merchant name, a type of merchant, purchase information, cardholder account information, a type of transaction, itinerary information, information regarding the purchased item and/or service, and/or other suitable information, is associated with a transaction and transmitted between parties to the transaction as transaction data, and may be stored by any of the parties to the transaction. In the exemplary embodiment, when cardholder 22 purchases travel, such as airfare, a hotel stay, and/or a rental car, at least partial itinerary information is transmitted during the clearance process as transaction data. When interchange network 28 receives the itinerary information, interchange network 28 routes the itinerary information to database 120.

For debit card transactions, when a request for a personal identification number (PIN) authorization is approved by the issuer, cardholder's account 32 is decreased. Normally, a charge is posted immediately to cardholder's account 32. The payment card association then transmits the approval to the acquiring processor for distribution of goods/services or information, or cash in the case of an automated teller machine (ATM).

After a transaction is authorized and cleared, the transaction is settled among merchant 24, merchant bank 26, and issuer bank 30. Settlement refers to the transfer of financial data or funds among merchant's 24 account, merchant bank 26, and issuer bank 30 related to the transaction. Usually, transactions are captured and accumulated into a “batch,” which is settled as a group. More specifically, a transaction is typically settled between issuer bank 30 and interchange network 28, and then between interchange network 28 and merchant bank 26, and then between merchant bank 26 and merchant 24.

FIG. 2 is a simplified block diagram of an example processing system 100 including a plurality of computer devices including a user device having a merchant recommender application in accordance with one example embodiment of the present invention. In the example embodiment, system 100 may be used for performing payment-by-card transactions received as part of processing the financial transaction. In addition, system 100 is a payment processing system that includes a merchant analytic (MA) computer system 121 configured to provide merchant recommendation data to a computing device using a merchant recommender application 119 stored thereon. As described below in more detail, MA computer system 121 is configured to collect transaction information and user search preference information, and recommend a list of merchants to a particular user via merchant recommender application 119 based on the received information.

More specifically, in the example embodiment, system 100 includes a server system 112, and a plurality of client sub-systems, also referred to as client systems 114, connected to server system 112. In one embodiment, client systems 114 are computers including a web browser, such that server system 112 is accessible to client systems 114 using the Internet or some other network connection configured for processing payment card transactions. Client systems 114 are interconnected to the Internet through many interfaces including a network, such as a local area network (LAN) or a wide area network (WAN), dial-in-connections, cable modems, and special high-speed Integrated Services Digital Network (ISDN) lines. Client systems 114 could be any device capable of interconnecting to the Internet including a web-based phone, PDA, or other web-based connectable equipment.

System 100 also includes point-of-sale (POS) terminals 115, which may be connected to client systems 114 and may be connected to server system 112. POS terminals 115 are interconnected to the Internet through many interfaces including a network, such as a LAN or a WAN, dial-in-connections, cable modems, wireless modems, and special high-speed ISDN lines. POS terminals 115 could be any device capable of interconnecting to the Internet and including an input device capable of reading information from a consumer's financial transaction card.

A database server 116 is connected to database 120, which contains information on a variety of matters, as described below in greater detail. In one embodiment, centralized database 120 is stored on server system 112 and can be accessed by potential users at one of client systems 114 by logging onto server system 112 through one of client systems 114 or by a merchant recommender application 119 stored on a cardholder computing device 118. In an alternative embodiment, database 120 is stored remotely from server system 112 and may be non-centralized.

Database 120 may include a single database having separated sections or partitions or may include multiple databases, each being separate from each other. Database 120 may store transaction data generated as part of sales activities conducted over the processing network including data relating to merchants, account holders or customers, issuers, acquirers, purchases made. Database 120 may also store account data including at least one of a cardholder name, a cardholder address, an account number, and other account identifiers. Database 120 may also store merchant data including a merchant identifier that identifies each merchant registered to use the network, and instructions for settling transactions including merchant bank account information. Database 120 may also store purchase data associated with items being purchased by a cardholder from a merchant, and authorization request data.

System 100 also includes at least one cardholder computing device 118, which is configured to communicate with at least one of POS terminals 115, client systems 114 and server system 112. In the example embodiment, cardholder computing device 118 is associated with or controlled by a cardholder making a purchase using system 100. Cardholder computing device 118 is interconnected to the Internet through many interfaces including a network, such as a LAN or WAN, dial-in-connections, cable modems, wireless modems, and special high-speed ISDN lines. Cardholder computing device 118 may be any device capable of interconnecting to the Internet including a web-based phone, smartphone, PDA, iPhone® (iPhone is a registered trademark of Apple, Incorporated located in Cupertino, Calif.), Android® device (Android is a registered trademark of Google Incorporated located in Mountain View, Calif.), and/or any device capable of executing stored computer-readable instructions. Cardholder computing device 118 is configured to communicate with POS terminals 115 using various outputs including, for example, Bluetooth communication, radio frequency communication, near field communication, network-based communication, and the like.

In the example embodiment, cardholder computing device 118 includes merchant recommender application 119, or recommender app 119. Recommender app 119 interfaces between a cardholder using cardholder computing device 118 and MA computer system 121. More specifically, recommender app 119 receives and transmits cardholder transaction information and cardholder search preference information input by the cardholder to MA computer system 121 either directly or through server 112. Transaction information may include a payment card number, an account number, cardholder information, a merchant identifier, and/or any other data relating to purchases made by a cardholder.

In the example embodiment, cardholder computing device 118 may initiate a transaction by transmitting payment card data to merchant POS device 115 or a cardholder can initiate a transaction by swiping a payment card at POS device 115. The transaction can then be processed, and settled, in a typical multi-party payment card industry system, e.g., system 20 (shown in FIG. 1). As described below, transaction data can then be transmitted to cardholder device 118 and displayed along with merchant recommendations through recommender app 119.

In the example embodiment, one of client systems 114 may be associated with acquirer bank 26 (shown in FIG. 1) while another one of client systems 114 may be associated with issuer bank 30 (shown in FIG. 1). POS terminal 115 may be associated with a participating merchant 24 (shown in FIG. 1) or may be a computer system and/or mobile system used by a cardholder making an on-line purchase or payment. Server system 112 may be associated with interchange network 28. In the exemplary embodiment, server system 112 is associated with a network interchange, such as interchange network 28, and may be referred to as an interchange computer system. Server system 112 may be used for processing transaction data. In addition, client systems 114 and/or POS terminal 115 may include a computer system associated with at least one of an online bank, a bill payment outsourcer, an acquirer bank, an acquirer processor, an issuer bank associated with a transaction card, an issuer processor, a remote payment system, and/or a biller. Further, in the example embodiment, MA computer system 121 is included in or is in communication with server system 112. In various embodiments, MA computer system 121 may be associated with a standalone processor or may be associated with a separate third party provider in a contractual relationship with interchange network 28 and configured to perform the functions described herein. Accordingly, each party involved in processing transaction data are associated with a computer system shown in system 100 such that the parties can communicate with one another as described herein.

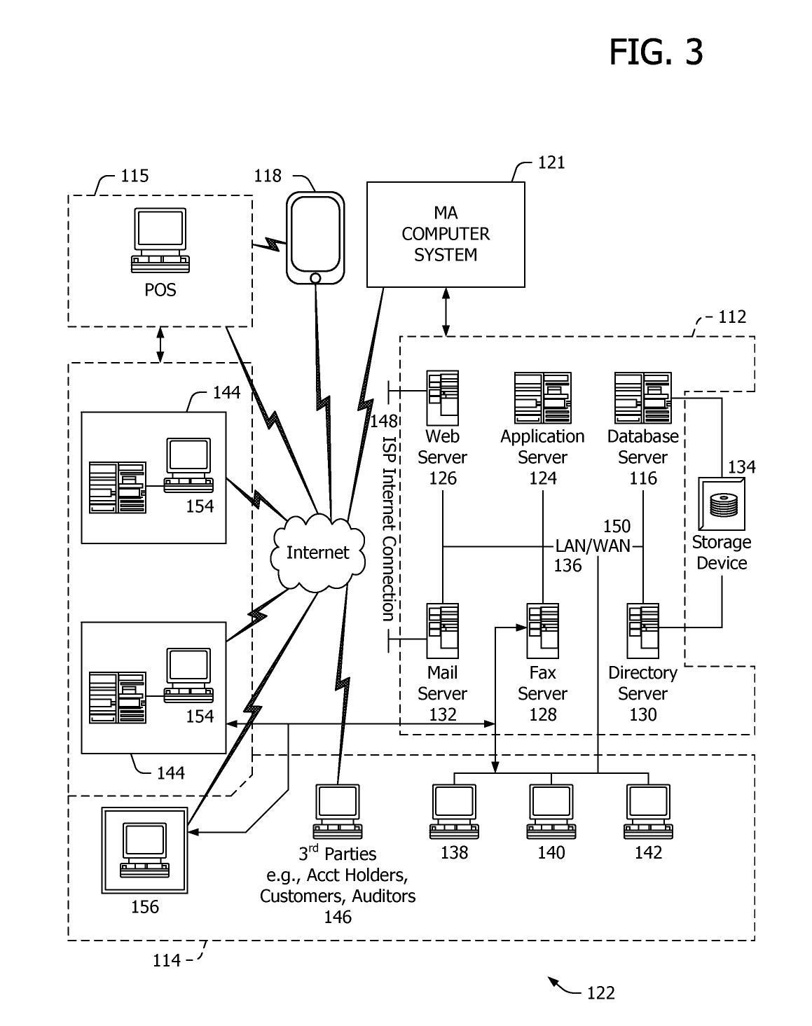

FIG. 3 is an expanded block diagram of an exemplary embodiment of a server architecture of a processing system 122 including other computer devices in accordance with one embodiment of the present invention. Components in system 122, identical to components of system 100 (shown in FIG. 2), are identified in FIG. 3 using the same reference numerals as used in FIG. 2. System 122 includes server system 112, client systems 114, and POS terminals 115. Server system 112 further includes database server 116, a transaction server 124, a web server 126, a fax server 128, a directory server 130, and a mail server 132. A storage device 134 is coupled to database server 116 and directory server 130. Servers 116, 124, 126, 128, 130, and 132 are coupled in a LAN 136. In addition, a system administrator's workstation 138, a user workstation 140, and a supervisor's workstation 142 are coupled to LAN 136. Alternatively, workstations 138, 140, and 142 are coupled to LAN 136 using an Internet link or are connected through an Intranet.

Each workstation, 138, 140, and 142 is a personal computer having a web browser. Although the functions performed at the workstations typically are illustrated as being performed at respective workstations 138, 140, and 142, such functions can be performed at one of many personal computers coupled to LAN 136. Workstations 138, 140, and 142 are illustrated as being associated with separate functions only to facilitate an understanding of the different types of functions that can be performed by individuals having access to LAN 136.

Server system 112 is configured to be communicatively coupled to various individuals, including employees 144 and to third parties, e.g., account holders, customers, auditors, developers, consumers, merchants, acquirers, issuers, etc., 146 using an ISP Internet connection 148. The communication in the exemplary embodiment is illustrated as being performed using the Internet, however, any other WAN type communication can be utilized in other embodiments, i.e., the systems and processes are not limited to being practiced using the Internet. In addition, and rather than WAN 150, local area network 136 could be used in place of WAN 150.

In the example embodiment, any authorized individual having a workstation 154 can access system 122. At least one of the client systems includes a manager workstation 156 located at a remote location. Workstations 154 and 156 are personal computers having a web browser. Also, workstations 154 and 156 are configured to communicate with server system 112. Furthermore, fax server 128 communicates with remotely located client systems, including a client system 156 using a telephone link. Fax server 128 is configured to communicate with other client systems 138, 140, and 142 as well.

In the example embodiment, MA computer system 121 is in communication with server system 112 and is in wireless communication with client systems 114, POS terminals 115, and/or cardholder computing device 118. Moreover, in the example embodiment, cardholder computing device 118 is in wireless communication with POS terminals 115 or, alternatively, may be in wireless communication with server system 112 or client systems 114 and other workstations through a network connection.

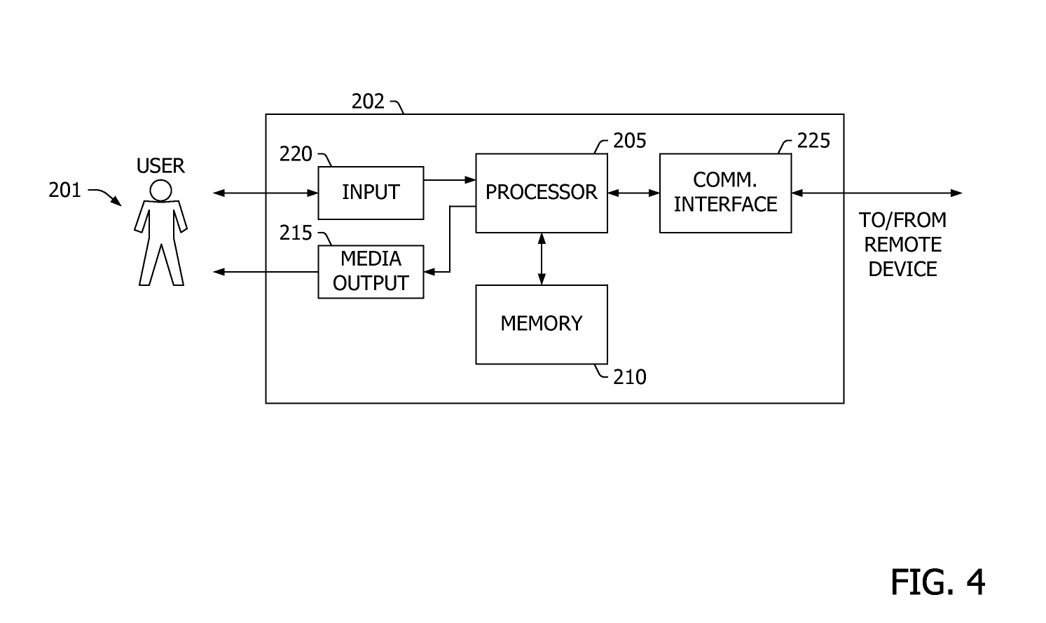

FIG. 4 illustrates an example configuration of a user system 202 operated by a user 201, such as cardholder 22 (shown in FIG. 1). User system 202 may include, but is not limited to, client systems 114, 138, 140, and 142, POS terminal 115, user device 118 including recommender app 119 (shown in FIG. 2), workstation 154, and manager workstation 156. In the example embodiment, user system 202 includes a processor 205 for executing instructions. In some embodiments, executable instructions are stored in a memory area 210. Processor 205 may include one or more processing units, for example, a multi-core configuration. Memory area 210 is any device allowing information such as executable instructions and/or written works to be stored and retrieved. Memory area 210 may include one or more computer readable media.

User system 202 also includes at least one media output component 215 for presenting information to user 201. Media output component 215 is any component capable of conveying information to user 201. In some embodiments, media output component 215 includes an output adapter such as a video adapter and/or an audio adapter. An output adapter is operatively coupled to processor 205 and operatively couplable to an output device such as a display device, a liquid crystal display (LCD), organic light emitting diode (OLED) display, or “electronic ink” display, or an audio output device, a speaker or headphones.

In some embodiments, user system 202 includes an input device 220 for receiving input from user 201. Input device 220 may include, for example, a keyboard, a pointing device, a mouse, a stylus, a touch sensitive panel, a touch pad, a touch screen, a gyroscope, an accelerometer, a position detector, or an audio input device. A single component such as a touch screen may function as both an output device of media output component 215 and input device 220. User system 202 may also include a communication interface 225, which is communicatively couplable to a remote device such as server system 112. Communication interface 225 may include, for example, a wired or wireless network adapter or a wireless data transceiver for use with a mobile phone network, Global System for Mobile communications (GSM), 3G, or other mobile data network or Worldwide Interoperability for Microwave Access (WIMAX).

Stored in memory area 210 are, for example, computer readable instructions for providing a user interface to user 201 via media output component 215 and, optionally, receiving and processing input from input device 220. A user interface may include, among other possibilities, a web browser and client application. Web browsers enable users, such as user 201, to display and interact with media and other information typically embedded on a web page or a website from server system 112. A client application allows user 201 to interact with a server application from server system 112.

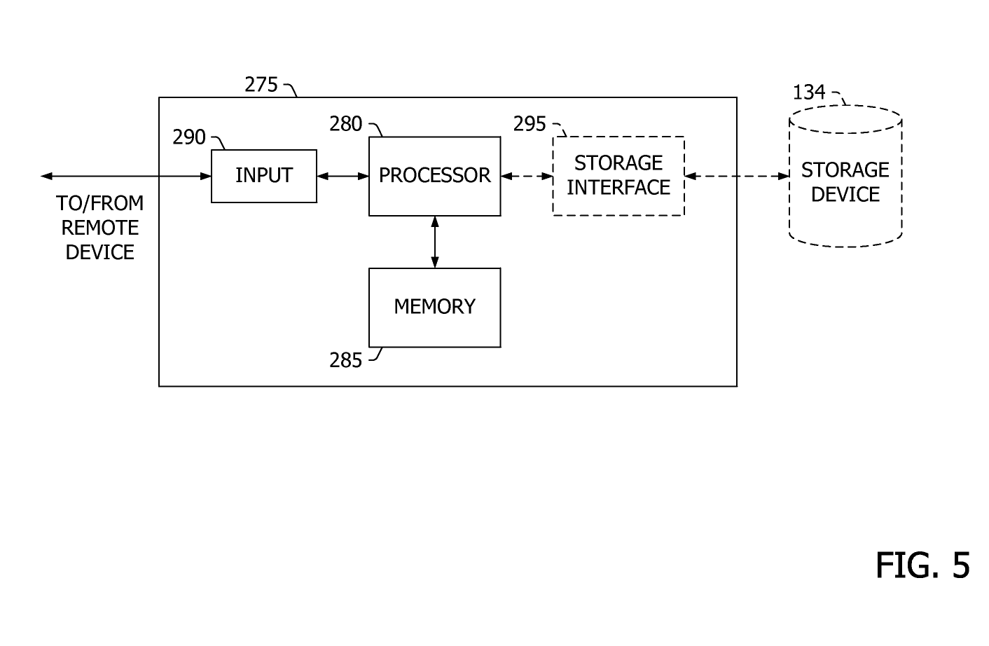

FIG. 5 illustrates an exemplary configuration of a server system 275 such as server system 112 (shown in FIGS. 2 and 3). Server system 275 may include, but is not limited to, database server 116, application server 124, web server 126, fax server 128, directory server 130, and mail server 132.

Server system 275 includes a processor 280 for executing instructions. Instructions may be stored in a memory area 285, for example. Processor 280 may include one or more processing units (e.g., in a multi-core configuration) for executing instructions. The instructions may be executed within a variety of different operating systems on the server system 275, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 280 is operatively coupled to a communication interface 290 such that server system 275 is capable of communicating with a remote device such as a user system or another server system 275. For example, communication interface 290 may receive requests from client system 114 via the Internet, as illustrated in FIGS. 2 and 3.

Processor 280 may also be operatively coupled to a storage device 134. Storage device 134 is any computer-operated hardware suitable for storing and/or retrieving data. In some embodiments, storage device 134 is integrated in server system 275. For example, server system 275 may include one or more hard disk drives as storage device 134. In other embodiments, storage device 134 is external to system 275 and may be accessed by a plurality of server systems 275. For example, storage device 134 may include multiple storage units such as hard disk drives or solid state drives in a redundant array of inexpensive disks (RAID) configuration. Storage device 134 may include a storage area network (SAN) and/or a network attached storage (NAS) system.

In some embodiments, processor 280 is operatively coupled to storage device 134 via a storage interface 295. Storage interface 295 is any component capable of providing processor 280 with access to storage device 134. Storage interface 295 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 280 with access to storage device 134.

Memory area 285 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

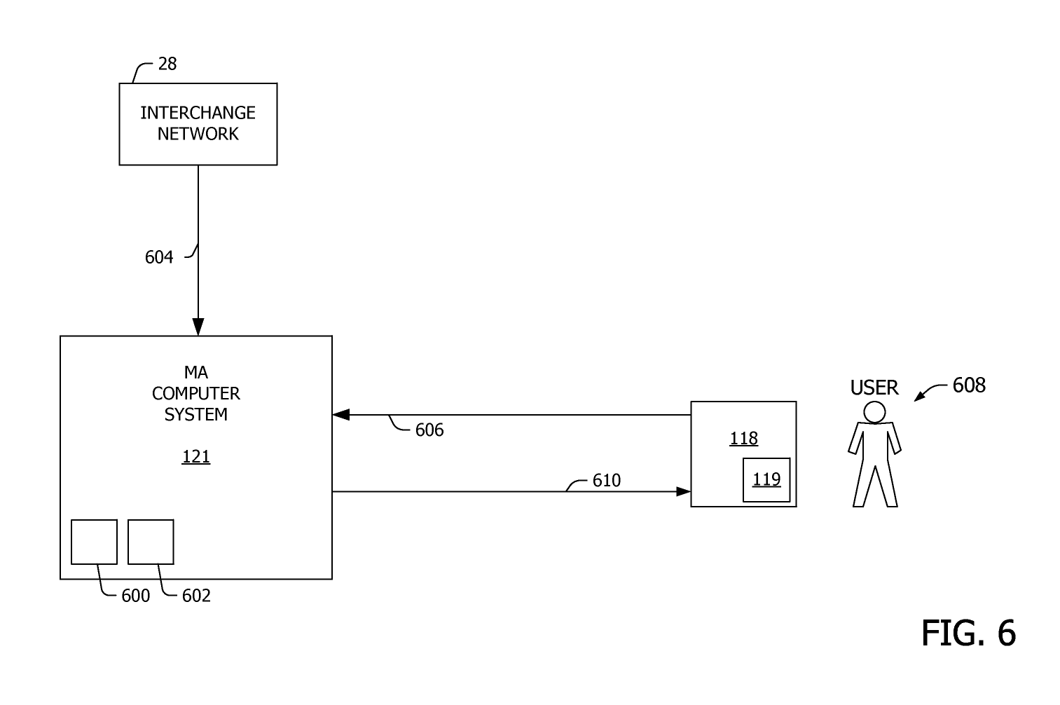

FIG. 6 is a block diagram showing operation of MA computer system 121 (shown in FIG. 2). In the example embodiment, MA computer system 121 is configured to collect transaction data for a plurality of cardholders transacting with a plurality of merchants, generate a list of merchants based on a number of local and unique cardholders, and display a list of recommended merchants based on a search location input by a user. In the example embodiment, MA computer system 121 is in communication with a payment network, such as payment card interchange network 28 (shown in FIG. 1), for receiving transaction information. MA computer system 121 includes a memory device 600 and a processor 602 in communication with memory device 600.

In the example embodiment, MA computer system 121 is programmed to communicate with payment network 28 to receive transaction information 604 for a plurality of payment cardholders. Transaction information 604 includes a merchant identifier for identifying a particular merchant involved in a transaction and other data relating to purchases made by a plurality of cardholders 22 at a plurality of merchants 24 during a predetermined time period. Payment network 28 is configured to process payment card transactions between merchants 24 associated with merchant banks 26, and cardholders 22 associated with issuer banks 30. In some embodiments, the plurality of purchases made by cardholder 22 are related to each other as being in the same market segment, for example, but not limited to a dining segment, an events segment, a night club segment, or an activities segment. The dining segment may include all purchases made at restaurants and food service merchants. The events segment may include all purchases that relate to concerts, sporting, or cultural events. The night club segment may include dance clubs and casinos. The activities segment may include amusement parks, and attractions.

Using transaction information 604, MA computer system 121 generates a list of cardholders (i.e., “cardholder list”) that have completed at least one transaction over payment network 28 during the predetermined time period. MA computer system 121 identifies each cardholder's residential zip code from the transaction information and sorts the cardholder list by cardholders according to zip code. In the example embodiment, the cardholder list is saved on memory device 600.

MA computer system 121 then generates a list of merchants (i.e., “merchant list”) that are located in each zip code on the cardholder list. In the example embodiment, MA computer system 121 generates a list of restaurants for each zip code. MA computer system 121 is configured to recommend restaurants favored by local residents. Accordingly, in the example embodiment, the restaurant list may exclude fast-food restaurants and/or chain restaurants as locals may be less likely to frequent these types of restaurants. The merchant list includes location data such as an address and/or latitude/longitude data for each merchant.

For each merchant on the merchant list, MA computer system 121 determines a total number of transactions completed for each merchant identifier over the predetermined time period. MA computer system 121 then determines a number of local cardholders involved in the total transactions for each merchant identifier using the cardholder list. In the example embodiment, a cardholder is “local” if the first three numbers of the cardholder's zip code are equal to the first three numbers of the merchant's zip code.

To prevent skewed results, MA computer system 121 also determines a number of unique cardholders that transacted with each merchant the predetermined time period. A cardholder is “unique” if the cardholder has not previously transacted with the merchant during the predetermined time period. Counting only unique cardholders protects the merchant popularity analysis by differentiating between merchants having a small, loyal customer-base and merchants having a large customer-base. Based on the collected information, non-local, unique transactions may also be determined, if desired. The merchant list includes at least the merchant location data, total transactions, and total local and unique cardholders. In one embodiment, MA computer system 121 sorts the merchant list in descending order with the merchant having the highest ratio of local and unique transactions to total transactions at the top. The merchant list is stored in a memory 600 and is updated as often as is desired.

MA computer system 121 is also programmed to receive search preference information 606, for example, a search location, from a user 608. User 608 inputs search preference information 606 using the Internet or cardholder computing device 118 (shown in FIG. 2) having recommender module 119 (shown in FIG. 2) stored thereon. In the example embodiment, search preference information 606 includes at least one of an address, a zip code, a town or city, and/or a current location of user 608. In some embodiments, where a large city covers multiple zip codes, MA computer system 121 may consider multiple zip codes that are nearby and/or contiguous to each other. MA computer system 121 determines which merchants from the merchant list are applicable to the user search preferences. MA computer system 121 sorts the merchant list in accordance with search preference information 606 and displays a recommended merchant list 610 to user 608 via media output 215 of cardholder computing device 118.

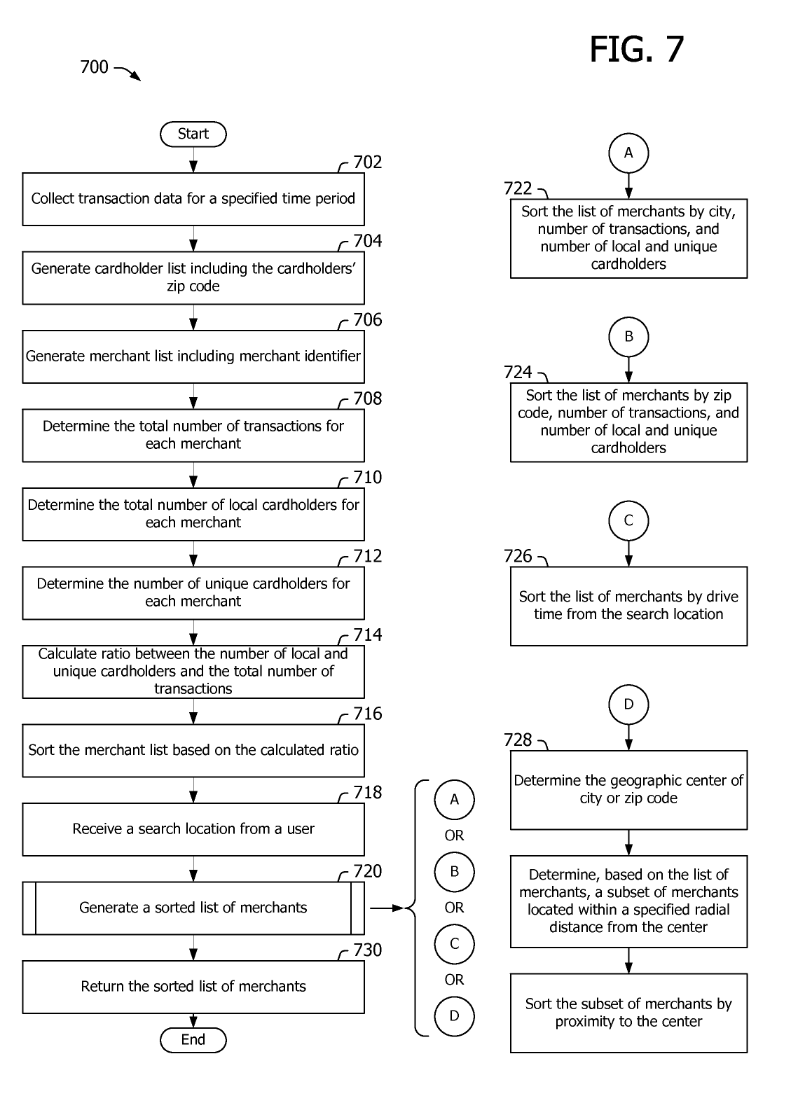

FIG. 7 is a flow diagram of an example method 700 of recommending at least one merchant of a plurality of merchants to a candidate cardholder using a computer device coupled to a database. In the example embodiment, method 700 may be implemented by MA computer system 121 (shown in FIG. 2).

In the example embodiment, MA computer system 121 collects 702 transaction information for a plurality of cardholders from a payment network. The transaction information includes a merchant identifier and other data relating to purchases made by the plurality of cardholders at a plurality of merchants during a predetermined time period.

Using the collected transaction information, MA computer system 121 generates 704 a cardholder list including cardholders that have completed at least one transaction over payment network 28 during the predetermined time period. MA computer system 121 identifies each cardholder's residential zip code from the transaction information and sorts the cardholder list by cardholders according to zip code. MA computer system 121 generates 706 a merchant list including each merchant identifier transacted with during the predetermined time period for each zip code on the cardholder list.

For each merchant on the merchant list, MA computer system 121 determines 708 a total number of transactions completed for each merchant identifier over the predetermined time period. MA computer system 121 then determines 710 a number of local cardholders involved in the total transactions for each merchant identifier using the cardholder list. In the example embodiment, a cardholder is “local” if the first three numbers of the cardholder's zip code are equal to the first three numbers of the merchant's zip code. MA computer system 121 also determines 712 a number of unique cardholders that transacted with each merchant the predetermined time period. A cardholder is “unique” if the cardholder has not previously transacted with the merchant during the predetermined time period.

In one embodiment, MA computer system 121 calculates 714 a ratio between the number of local and unique cardholders and the total number of transactions for each zip code. MA computer system 121 then sorts 716 the merchant list in descending order based on the calculated ratio. The merchant list may be stored on memory device 600.

In the example embodiment, MA computer system 121 is also programmed to receive 718 search preferences from a user inputted using a recommender app stored on a user computing device. Based on the search preferences received from the user, MA computer system 121 sorts 720 the merchant list using at least one of a number of methods.

In one embodiment, MA computer system 121 sorts 722 the merchant list by merchants located within a city's limits, the number of total transactions for each merchant within the specific time period, and the number of local and unique cardholders during the time period. In another embodiment, MA computer system 121 sorts 724 the list by merchants located within the specified zip code, the number of transactions, and the number of local and unique cardholders. In another embodiment, MA computer system 121 sorts 726 the list by travel time from the search location input by user 608. In yet another embodiment, MA computer system 121 determines a geographic center of the city or zip code input by user 608. Using the geographic center, MA computer system 121 determines a subset of merchants located within a specified radial distance from the geographic center. MA computer system 121 then sorts the subset of merchants by proximity to the geographic center, the number of transactions, and the number of unique visitors.

Once the merchant list is sorted, MA computer system 121 displays 730 the list of recommended merchants to the user. The list is representative of merchants that a large amount of local cardholders frequently transact with, but may not be known to non-local visitors.

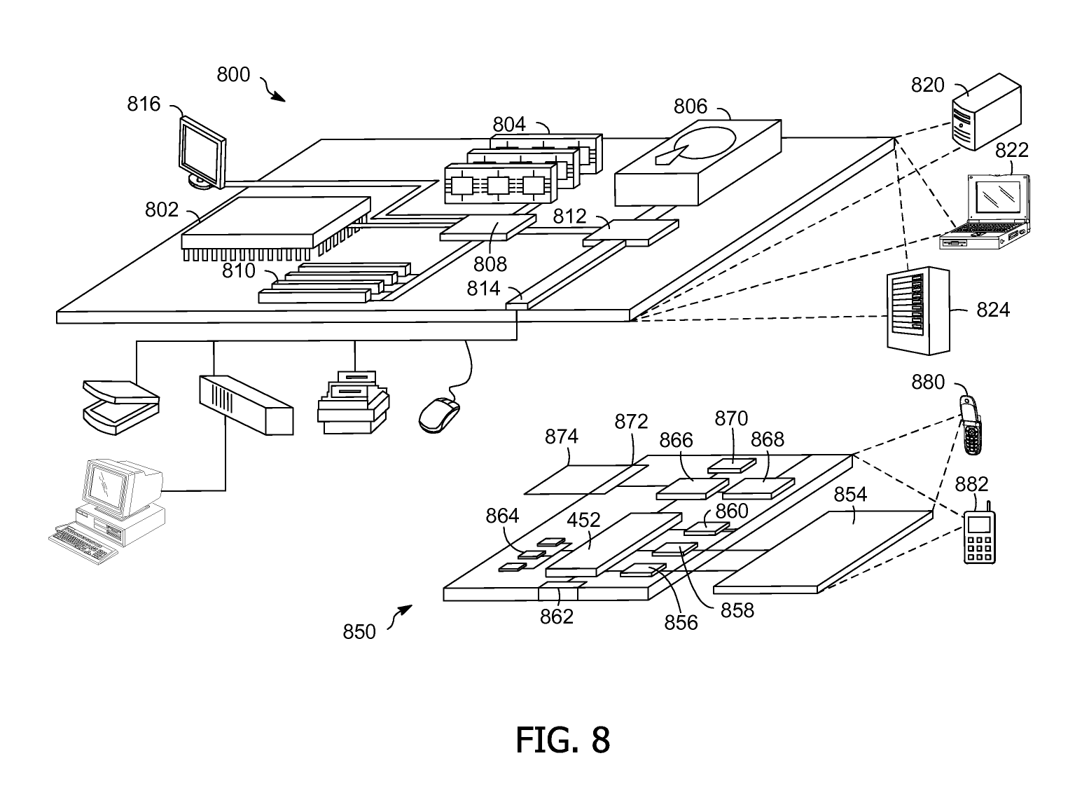

FIG. 8 is a diagram of example computing devices 800 and 850 that may be used in the system shown in FIG. 2. More specifically, FIG. 8 shows an example of a generic computing device 800 and a generic mobile computing device 850, which may be used with the techniques described here. Computing device 800 is intended to represent various forms of digital computers, such as laptops, desktops, workstations, personal digital assistants, servers, blade servers, mainframes, and other appropriate computers. Computing device 850 is intended to represent various forms of mobile devices, such as personal digital assistants, cellular telephones, smart phones, and other similar computing devices. The components shown here, their connections and relationships, and their functions, are meant to be examples only, and are not meant to limit implementations of the subject matter described and/or claimed in this document.

Computing device 800 includes a processor 802, memory 804, a storage device 806, a high-speed interface 808 connecting to memory 804 and high-speed expansion ports 810, and a low speed interface 812 connecting to low speed bus 814 and storage device 806. Each of the components 802, 804, 806, 808, 810, and 812, are interconnected using various busses, and may be mounted on a common motherboard or in other manners as appropriate. The processor 802 can process instructions for execution within the computing device 800, including instructions stored in the memory 804 or on the storage device 806 to display graphical information for a GUI on an external input/output device, such as display 816 coupled to high speed interface 808. In other implementations, multiple processors and/or multiple buses may be used, as appropriate, along with multiple memories and types of memory. Also, multiple computing devices 800 may be connected, with each device providing portions of the necessary operations (e.g., as a server bank, a group of blade servers, or a multi-processor system).

Memory 804 stores information within the computing device 800. In one implementation, the memory 804 is a volatile memory unit or units. In another implementation, the memory 804 is a non-volatile memory unit or units. The memory 804 may also be another form of computer-readable medium, such as a magnetic or optical disk.

The storage device 806 is capable of providing mass storage for the computing device 800. In one implementation, the storage device 806 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 804, the storage device 806, or memory on processor 802.

The high speed controller 808 manages bandwidth-intensive operations for the computing device 800, while the low speed controller 812 manages lower bandwidth-intensive operations. Such allocation of functions is for purposes of example only. In one implementation, the high-speed controller 808 is coupled to memory 804, display 816 (e.g., through a graphics processor or accelerator), and to high-speed expansion ports 810, which may accept various expansion cards (not shown). In the implementation, low-speed controller 812 is coupled to storage device 806 and low-speed expansion port 814. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 800 may be implemented in a number of different forms, as shown in the figure. For example, it may be implemented as a standard server 820, or multiple times in a group of such servers. It may also be implemented as part of a rack server system 824. In addition, it may be implemented in a personal computer such as a laptop computer 822. In other implementations, components from computing device 800 may be combined with other components in a mobile device (not shown), such as device 850. Each of such devices may contain one or more of computing device 800, 850, and an entire system may be made up of multiple computing devices 800, 850 communicating with each other.

Computing device 850 includes a processor 852, memory 864, an input/output device such as a display 854, a communication interface 866, and a transceiver 868, among other components. Device 850 may also be provided with a storage device, such as a microdrive or other device, to provide additional storage. Each of the components 850, 852, 864, 854, 866, and 868, are interconnected using various buses, and several of the components may be mounted on a common motherboard or in other manners as appropriate.

Processor 852 can execute instructions within the computing device 850, including instructions stored in the memory 864. The processor may be implemented as chips that include separate and multiple analog and digital processors. The processor may provide, for example, for coordination of the other components of the device 850, such as control of user interfaces, applications run by device 850, and wireless communication by device 850.

Processor 852 may communicate with a user through control interface 858 and display interface 856 coupled to a display 854. The display 854 may be, for example, a TFT LCD (Thin-Film-Transistor Liquid Crystal Display) or an OLED (Organic Light Emitting Diode) display, or other appropriate display technology. The display interface 856 may comprise appropriate circuitry for driving the display 854 to present graphical and other information to a user. The control interface 858 may receive commands from a user and convert them for submission to the processor 852. In addition, an external interface 862 may be in communication with processor 852, so as to enable near area communication of device 850 with other devices. External interface 862 may provide, for example, for wired communication in some implementations, or for wireless communication in other implementations, and multiple interfaces may also be used.

Memory 864 stores information within the computing device 850. Memory 864 can be implemented as one or more of a computer-readable medium or media, a volatile memory unit or units, or a non-volatile memory unit or units. Expansion memory 874 may also be provided and connected to device 850 through expansion interface 872, which may include, for example, a SIMM (Single In Line Memory Module) card interface. Such expansion memory 874 may provide extra storage space for device 850, or may also store applications or other information for device 850. Specifically, expansion memory 874 may include instructions to carry out or supplement the processes described above, and may include secure information also. Thus, for example, expansion memory 874 may be provided as a security module for device 850, and may be programmed with instructions that permit secure use of device 850. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer or machine-readable medium, such as the memory 864, expansion memory 874, or memory on processor 852 that may be received, for example, over transceiver 868 or external interface 862.

Device 850 may communicate wirelessly through communication interface 866, which may include digital signal processing circuitry where necessary. Communication interface 866 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 868. In addition, short-range communication may occur, such as using a Bluetooth, WiFi, or other such transceiver (not shown). In addition, GPS (Global Positioning system) receiver module 870 may provide additional navigation and location-related wireless data to device 850, which may be used as appropriate by applications running on device 850.

Device 850 may also communicate audibly using audio codec 860, which may receive spoken information from a user and convert it to usable digital information. Audio codec 860 may likewise generate audible sound for a user, such as through a speaker, e.g., in device 850. Such sound may include sound from voice telephone calls, may include recorded sound (e.g., voice messages, music files, etc.) and may also include sound generated by applications operating on device 850.

The computing device 850 may be implemented in a number of different forms, as shown in the figure. For example, it may be implemented as a cellular telephone 880. It may also be implemented as part of a smart phone 882, personal digital assistant, a computer tablet, or other similar mobile device.

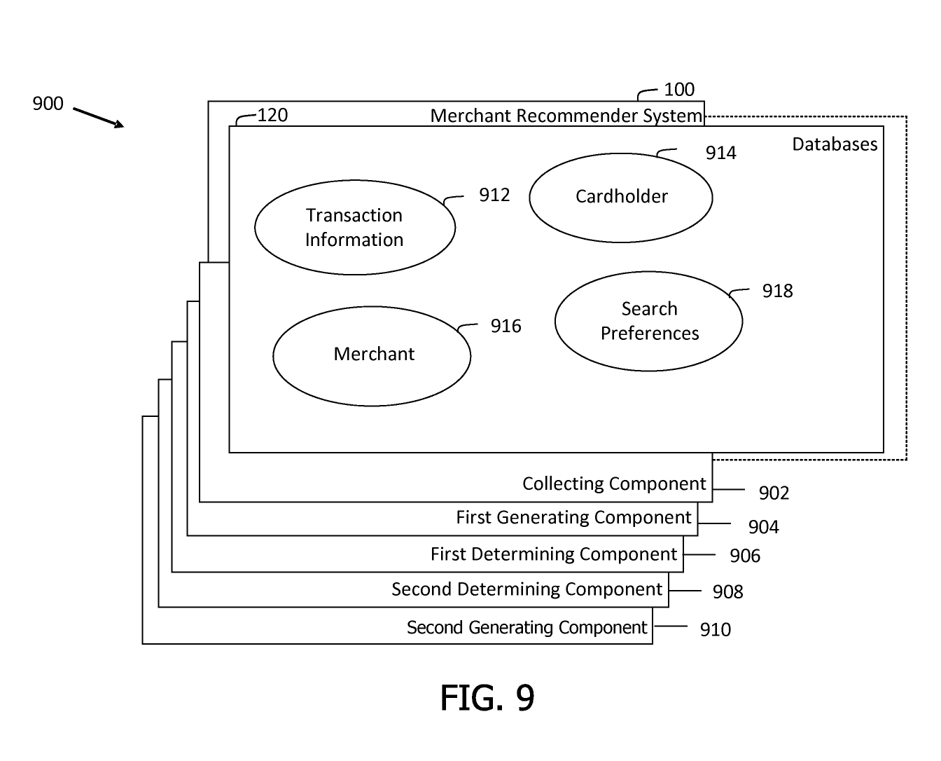

FIG. 9 is a diagram 900 of components of one or more example computing devices, for example computing devices 800 and/or 850 (FIG. 8), that may be used with merchant recommender system 100 shown in FIG. 2. For example, one or more of computing devices 800 and/or 850 may form MA computer system 121. FIG. 9 further shows a configuration of database 120 (shown in FIG. 2). Database 120 is coupled to several separate components within merchant recommender system 100, which performs specific tasks.

Merchant recommender system 100 includes a collecting component 902 for collecting transaction information 604 (shown in FIG. 6) for transactions between a plurality of payment cardholders and a plurality of merchants over a predetermined time period. System 100 also includes a first generating component 904 for generating a list of cardholders based on the transaction information, the cardholder list including a residential zip code associated with each cardholder. System 100 additionally includes a first determining component 906 for determining a total number of transactions for each merchant identifier based, at least in part, on the transaction information. System 100 additionally includes a second determining component 908 for determining a number of local and unique cardholders associated with each merchant identifier based, at least in part, on the transaction information and the cardholder residential zip codes. System 100 additionally includes a second generating component 910 for generating a list of merchants based on the total number of transactions and the number of local and unique cardholders.

In an exemplary embodiment, database 120 is divided into a plurality of sections, including but not limited to, a transaction information section 912, a cardholder section 914, a merchant section 916, and a search preferences section 918.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are exemplary only, and are thus not limiting as to the types of memory usable for storage of a computer program.

As will be appreciated based on the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications or code) include machine instructions for a programmable processor, and can be implemented in a high-level procedural and/or object-oriented programming language, and/or in assembly/machine language. As used herein, the terms “machine-readable storage medium” and “computer-readable storage medium” refer to any computer program product, apparatus and/or device (e.g., magnetic discs, optical disks, memory, Programmable Logic Devices (PLDs)) used to provide machine instructions and/or data to a programmable processor, including a machine-readable storage medium that receives machine instructions as a machine-readable signal. The term “machine-readable signal” refers to any signal used to provide machine instructions and/or data to a programmable processor. The machine-readable storage medium and computer-readable medium do not include transitory signals.

The above-described embodiments of a method and system of ranking merchants according to purchasing behaviors of local cardholders provide a cost-effective and reliable means for maintaining contact with a customer by merchants and a network interchange provider. As a result, the methods and systems described herein facilitate leveraging an payment network's assets to engage cardholders and merchants in an enhanced purchasing experience in a cost-effective and reliable manner.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A computer system for recommending a merchant to a candidate consumer, said computer system comprising:
a memory device for storing data; and
a processor in communication with said memory device, said processor programmed to:
collect transaction information for transactions between a plurality of payment cardholders and a plurality of merchants over a predetermined time period, the transaction information including a merchant identifier associated with each transaction;
generate a list of cardholders based on the transaction information, the cardholder list including a residential zip code associated with each cardholder;
determine a total number of transactions for each merchant identifier based, at least in part, on the transaction information;
determine a number of local and unique cardholders associated with each merchant identifier based, at least in part, on the transaction information and the cardholder residential zip codes; and
generate a list of merchants based on the total number of transactions and the number of local and unique cardholders.

2. A system in accordance with claim 1, wherein said processor is further programmed to:
determine a zip code for each merchant based on the merchant identifier;
compare the cardholder residential zip code to the merchant zip code for each cardholder that transacted with each merchant; and
determine a cardholder is local when first three numbers of the cardholder residential zip code are equal to the first three numbers of a merchant zip code.

3. A system in accordance with claim 1, wherein said processor is programmed to determine a cardholder is unique when the cardholder has not previously transacted with a particular merchant during the predetermined time period.

4. A system in accordance with claim 1, wherein said processor is further programmed to generate a merchant list including each merchant identifier transacted with during the predetermined time period.

5. A system in accordance with claim 1, wherein said processor is further programmed to:
calculate a ratio between the number of local and unique cardholders and the total number of transactions for each merchant; and
sort the merchant list in descending order based on the calculated ratio.

6. A system in accordance with claim 1, wherein said processor is further programmed to:
receive search preference information from the candidate consumer inputted using a recommender application stored on a user computing device;
sort the merchant list in accordance with the candidate consumer search preference information; and
display a list of recommended merchants to the candidate consumer.

7. A system in accordance with claim 6, wherein to sort the merchant list in accordance with the candidate consumer search preference information, said processor is further programmed to:
sort the merchant list by merchants located in a city specified by the candidate consumer;
sort the city-specific merchant list based on a ratio of the number of local and unique cardholders and the total number of transactions; and
display the list of recommended merchants located within the specified city based on the ratio.

8. A system in accordance with claim 6, wherein to sort the merchant list in accordance with the candidate consumer search preference information, said processor is further programmed to:
sort the merchant list by merchants located in a zip code specified by the candidate consumer;
sort the zip code specific merchant list based on a ratio of the number of local and unique cardholders and the total number of transactions; and
display the list of recommended merchants located within the specified zip code based on the ratio.

9. A system in accordance with claim 6, wherein to sort the merchant list in accordance with the candidate consumer search preference information, said processor is further programmed to:
receive a search location inputted by the candidate consumer, the search location including at least one of an address, a zip code, and a city; and
display the list of recommended merchants in ascending order based on travel time from the search location.

10. A system in accordance with claim 6, wherein to sort the merchant list in accordance with the candidate consumer search preference information, said processor is further programmed to:
determine a geographic center of one of a city and a zip code input by the candidate consumer;
determine a set of merchants from the merchant list located within a radial distance from the geographic center, the radial distance specified by the candidate consumer; and
display the list of recommended merchants in ascending order based on proximity to the geographic center.

11. A system in accordance with claim 1, wherein the plurality of merchants are associated with the same market segment.

12. A computer-implemented method of recommending at least one merchant of a plurality of merchants to a candidate consumer using a merchant analytic (MA) computer system, wherein the MA computer system is in communication with a memory device, said method comprising:
collecting transaction information for transactions between a plurality of payment cardholders and the plurality of merchants over a predetermined time period, the transaction information including a merchant identifier associated with each transaction;
generating a list of cardholders based on the transaction information, the cardholder list including a residential zip code associated with each cardholder;
determining a total number of transactions for each merchant identifier based, at least in part, on the transaction information;
determining a number of local and unique cardholders associated with each merchant identifier based, at least in part, on the transaction information and the cardholder residential zip codes; and
generating a list of merchants based on the total number of transactions and the number of local and unique cardholders.

13. A method in accordance with claim 12, further comprising:
determining a zip code for each merchant based on the merchant identifier;
comparing the cardholder residential zip code to the merchant zip code for each cardholder that transacted with each merchant; and
determining a cardholder is local when first three numbers of the cardholder residential zip code are equal to the first three numbers of a merchant zip code.

14. A method in accordance with claim 12, further comprising determining a cardholder is unique when the cardholder has not previously transacted with a particular merchant during the predetermined time period.

15. A method in accordance with claim 12, further comprising:
calculating a ratio between the number of local and unique cardholders and the total number of transactions for each merchant; and
sorting the merchant list in descending order based on the calculated ratio.

16. A method in accordance with claim 12, further comprising:
receiving search preference information from the candidate consumer inputted using a recommender application stored on a user computing device;
sorting the merchant list in accordance with the candidate consumer search preference information; and
displaying a list of recommended merchants to the candidate consumer.

17. A method in accordance with claim 16, further comprising:
sorting the merchant list by merchants located within a search location specified by the candidate consumer, the search location including one of a city and a zip code;
sorting the location-specific merchant list based on a ratio of the number of local and unique cardholders and the total number of transactions; and
displaying the list of recommended merchants located within the search location based on the ratio.

18. One or more computer-readable storage media having computer-executable instructions embodied thereon for recommending at least one merchant of a plurality of merchants to a candidate consumer, wherein when executed by at least one processor, the computer-executable instructions cause the processor to:
collect transaction information for transactions between a plurality of payment cardholders and a plurality of merchants over a predetermined time period, the transaction information including a merchant identifier associated with each transaction;
generate a list of cardholders based on the transaction information, the cardholder list including a residential zip code associated with each cardholder;
determine a total number of transactions for each merchant identifier based, at least in part, on the transaction information;
determine a number of local and unique cardholders associated with each merchant identifier based, at least in part, on the transaction information and the cardholder residential zip codes; and
generate a list of merchants based on the total number of transactions and the number of local and unique cardholders.

19. The computer-readable storage media of claim 18, wherein the computer-executable instructions further cause the processor to:
receive a search location from the candidate consumer inputted using a recommender application stored on a user computing device, the search location including at least one of an address, a zip code, and a city;
sort the merchant list in accordance with the candidate consumer search preference information; and
display a list of recommended merchants to the candidate consumer in ascending order based on travel time from the search location.

20. The computer-readable storage media of claim 18, wherein the computer-executable instructions further cause the processor to:
receive a search location from the candidate consumer inputted using a recommender application stored on a user computing device, the search location including at least one of a city and a zip code;
determine a geographic center of the search location;
determine a set of merchants from the merchant list located within a radial distance from the geographic center, the radial distance specified by the candidate consumer; and
display the list of recommended merchants in ascending order based on proximity to the geographic center.
